(19) United States
(12) Patent Application Publication
(10) Pub. No.: US 2002/0060694 A1
(43) Pub. Date: May 23, 2002

(54) Method and apparatus for sending an information request over a network

(75) Inventors: Kazuki Matsui, Akashi (JP); Youji Kohda, Kobe (JP); Noboru Iwayama, Akashi (JP); Soichi Nishiyama, Ichikawa (JP); Hitoshi Okumura, Yokohama (JP)

Correspondence Address: STAAS & HALSEY LLP, 700 11TH STREET, NW, SUITE 500, WASHINGTON, DC, 20001, US

(73) Assignee: FUJITSU LIMITED, KAWASAKI (JP)

(21) Appl. No.: 09/987,886

(22) Filed: Nov. 16, 2001

(30) Foreign Application Priority Data
Nov. 17, 2000 (JP) 2000-351769
May 28, 2001 (JP) 2001-158132

(51) Int. Cl. G09G 5/00

(52) U.S. Cl. 345/733

(57) ABSTRACT

Enabling a symbolic image representing the service provider or information provider to be displayed on a user terminal, displaying the predetermined domain for sending an application for use of services and of information and an application for use of services and distribution of information and adjustment of amount and content of information to be distributed for the service provider and information distributing source by detecting that a symbolic image has been moved to the predetermined domain.

### CROSS-REFERENCE TO RELATED APPLICATIONS

This application is based upon and claims priority of Japanese Patent Applications Nos. 2000-351769 filed Nov. 17, 2000 and 2001-158132 filed May 28, 2001, the contents being incorporated herein by reference.

### BACKGROUND OF THE INVENTION

1. Field of the Invention

The present invention relates to various service providing systems and information distribution systems for providing desired services and information pieces to a relevant user by accepting service applications and information requests from the relevant user via a network.

2. Description of the Related Art

In recent years, rapid spread of various networks such as the Internet or the like enables an information provider to occasionally or periodically transmit information to be provided to predetermined transmitting destinations, namely users, by previously registering the desired information and the distribution destinations thereof and the user to receive the desired information for making reference thereto. As an example, when the user desires the distribution of news, the user executes the following procedures.

First, the user accesses the home-page of the news information provider. In this homepage, a page for applying for the distribution of news is prepared and the user displays the application transmission page. Here, the user inputs displayed description items (name and information sending destination address or the like) required for the application and clicks the application button or transmits the input data to the predetermined application address. The news distributor receives the transmitted application data, registers the distribution destination address or the like to the stored distribution management database, registers the news information distribution destination and thereafter starts distributing news to the user.

Even in the case of an online shopping system or the like, a person who desires to become the user may be registered as a member of the distribution destination by inputting and transmitting the predetermined information to the member information registering image and questionnaire image. After registration to the distribution destination, the news information and advertisement information are periodically and occasionally distributed to the user.

Moreover, when reserving an airplane ticket, each time the user accesses the reservation services of the respective airlines and confirms the vacancy conditions and applies for a reservation by inputting the necessary input items.

### SUMMARY OF THE INVENTION

As explained above, the user has inputted, for each distributor, the application contents requested from the distributor. Namely, the user has been urged to input the same contents for many times as the number of distributors to obtain the information increases. Moreover, input contents required at the time of sending the application and the layout prepared for inputting such contents are different for each distributor. Therefore, the user is requested to send the application, after sufficiently understanding the application method, for each application.

In addition, even when the user desires to enjoy the services provided, the user also has been requested to execute the troublesome application procedures through connection to the desired service providers.

Moreover, even when the user is forcibly requested to repeatedly execute the troublesome application procedures, it is difficult to know the user's interest level in the relevant service and information and to provide the services and information depending on the user's level of interest only considering the input items requested from the user at the time of sending the application. However, it is more troublesome to urge the user to input information to detect the user's interest level at the time of sending the application procedures and therefore it is assumed that the user will cancel execution of application procedures.

It is therefore an object of the present invention to allow the user to apply to receive the services provided and information distribution through a simplified interface. Moreover, it is an object of the present invention that contents of the provided service and information can be adjusted depending on the user's interest level by easily detecting the user's interest level for the relevant service and information even while the application procedures are executed through the simplified interface.

In short, in view of achieving the objects explained above, the present invention is characterized in forming a system structure where a unique symbolic image (icon or the like) integrating the information provider's connection destination information is previously acquired and displayed on the user's display terminal via a network connection to the connecting destination having the relevant icon. The integration is automatically completed in such a timing that the selected icon is moved to the predetermined access domain on the same display image and the procedure information required to receive the information is automatically transmitted. With the structure explained above, the user can be freed from the troublesome input manipulation to fetch the desired symbolic image and can complete the necessary procedures only by moving the icon on the display image.

Namely, in the present invention, a service provider or a symbolic image representing the information provider is prepared and the corresponding service or information which can be connected to the information provider is previously stored and associated with the relevant symbolic image. The relevant symbolic image is displayed on the user's terminal and the predetermined domain to declare that the user requests services or information is also displayed on the display image. Moreover, the present invention provides a system such that when the user moves a symbolic image representing the service provider or information provider displayed on the display to the predetermined domain, this movement is detected and services or information is requested from the service provider or information provider corresponding to the relevant symbolic image. Thereby, the user can transmit the application to receive the services and information distribution request by merely selecting the symbolic image representing the desired service or information using an instruction input device such as a mouse and with simplified work such as by moving the symbolic image without any troublesome input manipulation.

Moreover, the present invention also provides a system to recognize a display position of the relevant symbolic image or the like and to determine from such display position or the like how interested the user is in the service and/or information corresponding to the relevant symbolic image. Thereby, the user can not only request the services and information but also determine the interest level in such service and information only by positioning the symbolic image to the desired domain and moreover can request the services or information depending on the user's interest level or a ranking thereof.

Namely, the present invention is characterized in displaying the symbolic image representing the information provider or service provider on the user terminals, moreover displaying the predetermined domain for declaring that the user sends the service or information request, thereby detecting that the user has selected the symbolic image displayed on the display image and moved the image to the predetermined domain and sent the request for services or information to the service provider or information provider corresponding to the relevant symbolic image.

In addition, the present invention is also characterized in determining the user's interest level depending on the display position of moved symbolic image and requesting the services and information depending on the user's interest level.

Moreover, the present invention is also characterized in that the service or information can be provided depending on the situation of the user and tendency of interest by providing a function to provide the service and/or information using another symbolic image information as related information when a plurality of symbolic images are selected by the user.

In more detail, the present invention is an information providing system for receiving an information distribution request from a user via a network and distributing the desired information to the user, comprising an information provider display displaying a symbolic image representing an information provider on a user terminal; an information requesting domain display displaying, on the user terminal, an information request domain to accept an information request; a detector detecting that a user has selected one or a plurality of symbolic images corresponding to the information provider to detect that the selected symbolic image is moved to the information requesting domain; an information requesting unit identifying the symbolic image detected with the detector and transmitting generated data for requesting information from the information provider corresponding to the selected symbolic image; and an information display displaying the information distributed from the information requesting unit.

### BRIEF DESCRIPTION OF THE DRAWINGS

FIG. 1 is a diagram illustrating the total structure of an embodiment of the present invention.

FIG. 2 is a flow chart according to an embodiment of the present invention.

FIG. 3A is a flow chart of a distribution reservation requesting unit according to an embodiment of the present invention.

FIG. 3B is a flow chart of a distribution reservation management unit according to an embodiment of the present invention.

FIG. 3C is a flow chart of the distribution reservation management unit according to an embodiment of the present invention.

FIG. 4 is a flow chart of a cancel requesting process according to an embodiment of the present invention.

FIG. 5 is a diagram illustrating an example of content of the member information DB according to an embodiment of the present invention.

FIG. 6 is a diagram illustrating an example of a display image according to an embodiment of the present invention.

FIG. 7 is a diagram illustrating an example of content of icon data according to an embodiment of the present invention.

FIG. 8 is a diagram illustrating an example of a format of the distribution reservation data according to an embodiment of the present invention.

FIG. 9 is a diagram illustrating an example of content of the distribution reservation registration DB according to an embodiment of the present invention.

FIG. 10 is a flow chart of an information distributing unit according to an embodiment of the present invention.

FIG. 11 is a diagram illustrating an example of content of the content DB according to an embodiment of the present invention.

FIG. 12 is a diagram illustrating an example of content of the distribution reservation management DB according to an embodiment of the present invention.

FIG. 13 is a diagram illustrating another example of content of the content DB according to an embodiment of the present invention.

FIG. 14 is a diagram illustrating an example of content of the peripheral information data according to an embodiment of the present invention.

FIG. 15 is a diagram illustrating an example of the display image in the case where the present invention is applied to a shopping cart system.

FIG. 16 is a diagram illustrating an example of the display image in the case where the present invention is applied to a reservation system.

FIG. 17 is a diagram illustrating a second example of the display image in the case where the present invention is applied to a reservation system.

FIG. 18 is a diagram illustrating a third example of the display image in the case where the present invention is applied to a reservation system.

FIG. 19 is a diagram illustrating a fourth example of the display image in the case where the present invention is applied to a reservation system.

FIG. 20 is a diagram illustrating a fifth example of the display image in the case where the present invention is applied to a reservation system.

FIG. 21 is a diagram illustrating a sixth example of the display image in the case where the present invention is applied to a reservation system.

FIG. 22 is a diagram illustrating an example of the display image in the case where the present invention is applied to a talent information service.

FIG. 23 is a diagram illustrating a second example of the display image in the case where the present invention is applied to a talent information service.

FIG. 24 is a diagram illustrating a third example of the display image in the case where the present invention is applied to a talent information service.

FIG. 25 is a diagram illustrating a fourth example of the display image in the case where the present invention is applied to a talent information service.

FIG. 26 is a diagram illustrating a display example of an advertisement requesting domain according to an embodiment of the invention.

FIG. 27 is a diagram illustrating an example of content of the content DB according to an embodiment of the present invention.

FIG. 28 is a diagram illustrating a total structure of another embodiment of the present invention.

FIG. 29 is a flow chart of processes of an information distributing unit according to an embodiment of the present invention.

FIG. 30 is a diagram illustrating an example of content of the sub-content DB according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings, wherein like reference numerals refer to like elements throughout.

An example where the present invention is embodied in combination with a virtual social space service will be explained.

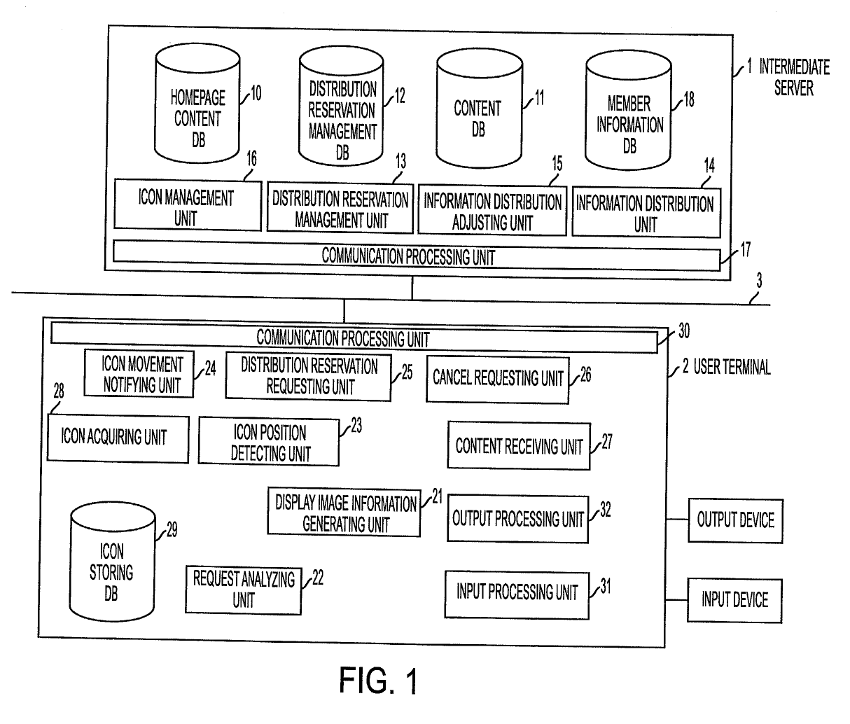

FIG. 1 illustrates an example of the structure of an advertisement distribution system realized on the virtual social space service to which the present invention is applied. In this structure, an intermediate server 1 and a plurality of user terminals 2 are connected via the network 3. In this figure, only one user terminal 2 is illustrated as the typical user terminal. The intermediate server 1 provides a virtual social space and is also used for integral management of the information provided from shops and companies or the like which are taking part in such virtual social space. The intermediate server 1 comprises a homepage content database DB 10 storing content of homepages provided from shops and companies or the like which are taking part in the virtual social space and icon data relating to the symbolic images or the like used to display the shops and companies in the virtual social space, an icon management unit 16 used for management of the homepage content DB 10, a member information DB 18 storing user information of the users to receive the virtual social space service, content DB 11 storing advertisement contents, a distribution reservation management DB 12 for accepting and registering the user's distribution requests, a communication processing unit 17 for communicating via the terminals 2 and network 3 and a distribution reservation management unit 13 for registering the information about the distribution destination to the distribution reservation management DB 12 based on the notified content, which further comprises an information distribution unit 14 for distributing information based on the distribution reservation management DB 12 and content DB 11 with inclusion of an information distribution adjusting unit 15 for adjusting a distribution amount depending on the rank of user's interest.

The user terminal 2 comprises an input processing unit 31 for receiving an input signal from an input device, an output processing unit 32 for transmitting an output signal to an output device, a request analyzing unit 22 for analyzing input device manipulation content received with the input processing unit 31 and transferring, when it is determined that the icon was manipulated, information relating to the icon manipulation to an icon position detecting unit 23, the icon position detecting unit 23 receiving information about the icon manipulation from the request analyzing unit 22 and transmitting the information about the relevant icon to an icon movement notifying unit 24, a distribution reservation requesting unit 25 and a cancellation requesting unit 26 depending on the icon manipulation, a content receiving unit 27 for receiving the distributed advertisement information to instruct that the advertisement information be displayed onto a display image information generating unit 21, the display image information generating unit 21 displaying a street layout under the management to each user and an icon acquiring unit 28 for temporarily storing the icon data to an icon storing DB 29 depending on the icon manipulation.

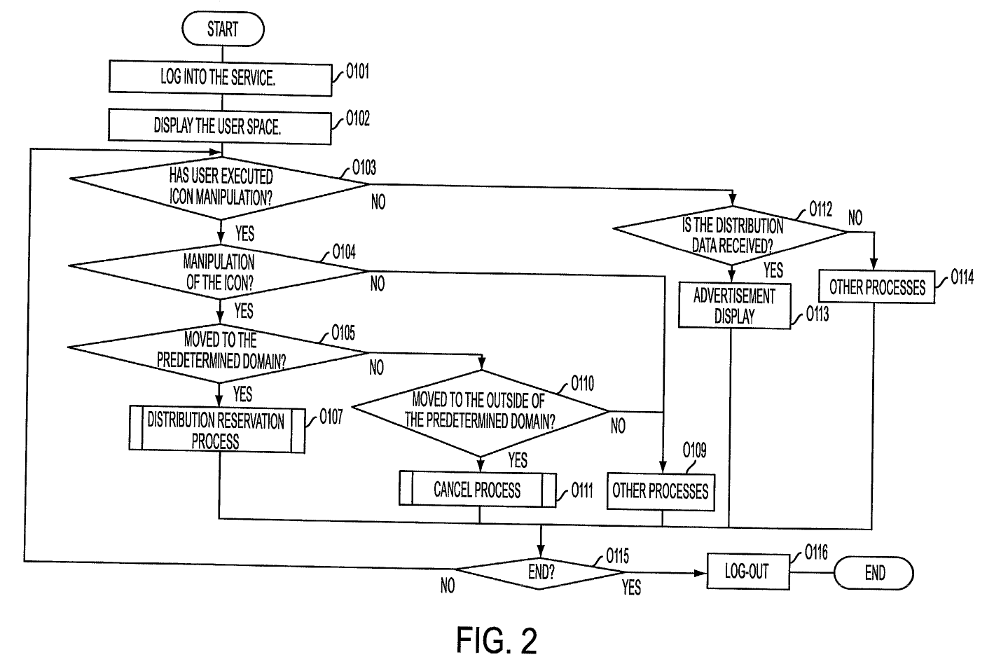

The flow of processes in the present invention incorporated to the virtual social space service will be explained with reference to FIG. 2.

The virtual social space service introduces the membership system and the user information is registered to the member information DB 18 using a user ID 181 required for use of the service as a key. An example of content of the member information DB 18 is illustrated in FIG. 5. The member information DB 18 is structured with the user ID 181, a password 182, a personal information profile 183 and street layout information 184, or the like. The user ID 181 is an identification number for identifying users in the virtual social space service and is uniquely given to each user from the relevant service. The password 182 is a secret number for confirming that the relevant user is the legitimate user. The personal information profile 183 registers a file name in which the basic information pieces such as the user's name, age and sex or the like are stored. It is also possible that the basic information pieces are not stored as a file but rather information is stored by providing respective items to the member information DB 18. The street layout information 184 stores the street layout information generated depending on the personal favorite in the virtual social spacer service. The street layout information 184 is generated with the icon movement notifying unit 24 depending on the street layout condition defined with the user through mouse manipulation, which is then stored. The icon movement notifying unit 24 executes the process to notify the icon moving position or the like according to a predetermined timing using an ordinary protocol such as HTTP or the like but this function is an intrinsic function of the virtual social space service and is not the main function of the present invention. Therefore the detailed explanation of this function will be omitted here.

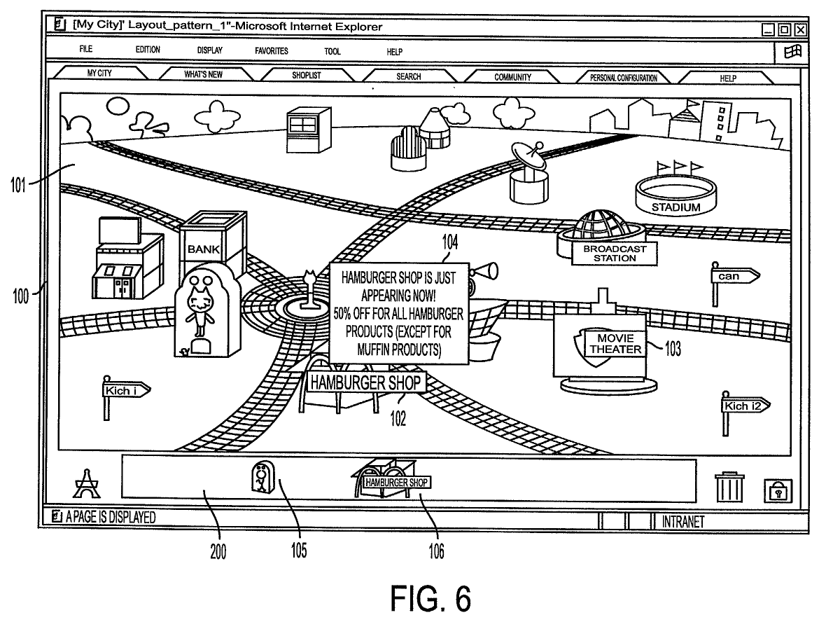

As shown in FIG. 2, first, the user logs into the virtual social space service in operation O101 by inputting the user ID and password using a user terminal 2. In this embodiment, it is assumed that the user having a user ID of MC010149 has logged in. The intermediate server 1 searches the member information DB 18 based on the user ID sent from the user terminal 2 to confirm that the password inputted by the user matches the password 182 registered to the member information DB 18. If these passwords do not match, the service application is not allowed. When the passwords match, the service application is allowed and the street layout information of the relevant user 184 (content stored in the file mc10149.swf in the example shown in FIG. 5 is transmitted to the user terminal 2. Upon receiving the street layout information via the communication processing unit 30, the user terminal 2 displays the user street layout on the display unit in the display image information generating unit 21 in operation O102. Display image in the virtual social space service (MyCity) provided by the applicant of the present invention is illustrated in FIG. 6.

The display image is roughly classified for display into virtual social space 100 and advertisement requesting domain 200. In this embodiment, the scenery 101, shops 102 and leisure facility 103 or the like in the city of the virtual social space 100 are selected and allocated depending on the user's favorite. Each shop 102 and leisure facility 103 are represented by icons. The display positions of the icons 102, 103 in the virtual social space 100 are linked according to the user's interest level of such shops and leisure facilities represented by the icons and, when the icons are located at the forward domain, it indicates that the user's interest is considerably high and when such icons are located at the deeper domain, it indicates that the user's interest is rather low. The icons of these shops 102 and leisure facilities 103 correspond to the symbolic images representing the service provider, information provider and advertisement distributor in the present specification. Moreover, the advertisement requesting domain 200 corresponds to the predetermined domain of the present specification.

Whether the user manipulates the input device in the virtual social space 100 displayed on the display unit is monitored. When it is detected that a certain manipulation is executed, a YES in operation O103 shown in FIG. 2, the process moves on to operation O104. If not, or a NO in operation O103 in FIG. 2, reception of the distribution data is confirmed in operation O112 of FIG. 2. When the distribution data is received, a YES in operation O112 of FIG. 2, the distributed advertisement data is displayed on the display device in operation O113 of FIG. 2. If the distribution data is not received, a NO in operation O112 of FIG. 2, the user mouse manipulation or the process depending on the content of data received from the server is executed in operation O114.

When it is detected that the user has executed a certain manipulation, a YES in operation O103 of FIG. 2, it is confirmed whether the icon manipulation is executed in operation O104 of FIG. 2. If the icon manipulation is not executed, a NO in operation O104 of FIG. 2, the corresponding other process is executed in operation O102 of FIG. 2. When a certain icon manipulation is executed, it is confirmed whether the icon has been moved to the predetermined domain in operation O105 of FIG. 2. When the icon has been moved to the predetermined domain, a YES in operation O105 of FIG. 2, the distribution reservation process is executed in operation O107 of FIG. 2. If the icon is not moved to the predetermined domain, a NO in operation O105 of FIG. 2, it is confirmed whether the icon has been moved to the other domain from the predetermined domain in operation O110 of FIG. 2. When the icon has been moved to the other domain from the predetermined domain, a YES in operation O110 of FIG. 2, the cancel request process is executed in operation O111 of FIG. 2. Details of the distribution reservation process and cancel request process will be explained later.

After respective processes are executed, whether the user has requested an end of service is confirmed in operation O115 of FIG. 2. When instruction to complete the service is issued, a YES in operation O115 of FIG. 2, the service is logged out in operation O116 of FIG. 2. If the instruction to complete the service is not issued, a NO in operation O115 of FIG. 2, the process returns to operation O103 to wait for the next manipulation or the reception of the distribution data.

Coarse flow of the advertisement distribution system utilizing the virtual social space system is as explained above.

The advertisement distribution system will be explained practically on the basis of the display example of FIG. 6.

In the display image of FIG. 6, it is assumed that the icon 102 of the shop allocated in the virtual social space 100 is dragged and dropped to the advertisement requesting domain 200. As explained above, the request analyzing unit 22 of the user terminal 2 detects that the icon has been manipulated using a mouse and then notifies the icon position detecting unit 23 that the icon has been manipulated. In this case, the coordinates at the time of executing the drag and the coordinates after the drop are transmitted. From the coordinates of the icon before and after the movement thereof, the icon position detecting unit 23 determines that the icon has been copied to the advertisement requesting domain 200 from the virtual social space 100 and then transmits the icon data and coordinate data to the distribution reservation requesting unit 25 to request the distribution reservation.

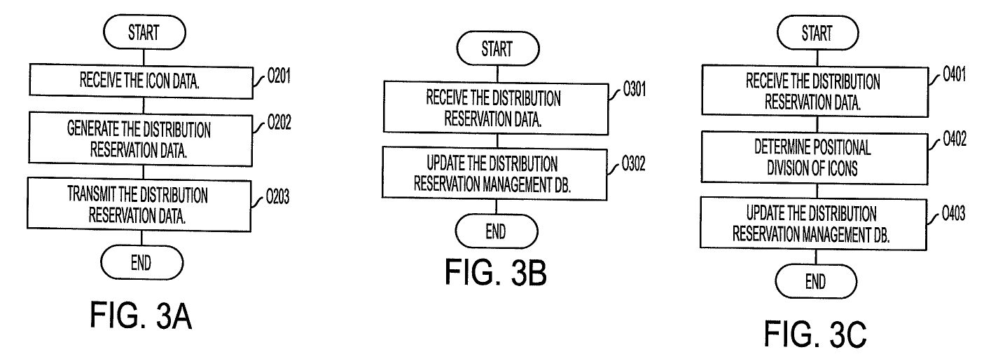

The process of distribution reservation will be explained with reference to FIG. 3.

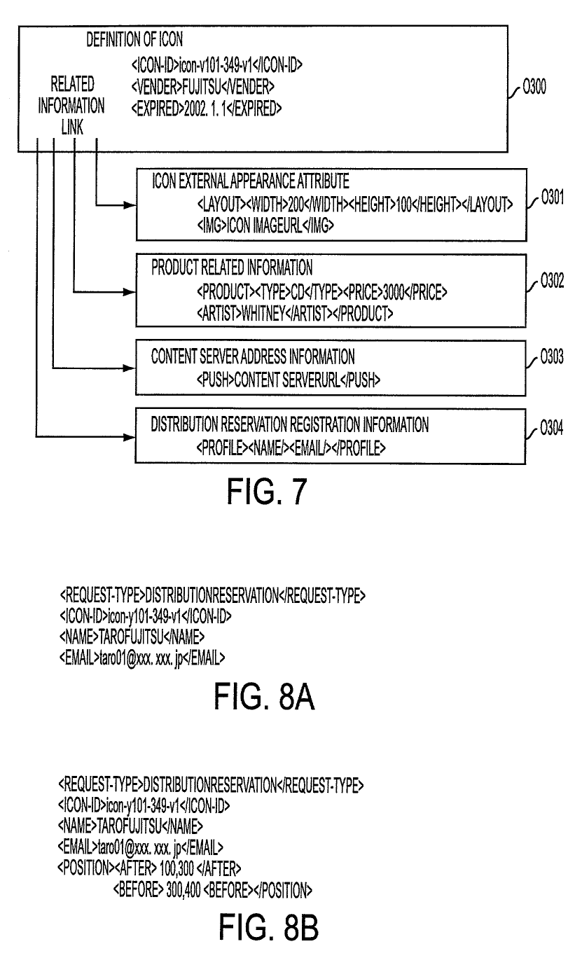

The distribution reservation requesting unit 25 acquires, upon receiving the icon data in operation O201 of FIG. 3, the items required for distribution reservation defined in the received icon data from the member information DB 18. An example of the icon data is illustrated in FIG. 7. FIG. 7 illustrates an example in which the icon data is defined using the XML language. The icon data is composed of an icon defining area 300, an icon appearance attribute area 301, a product-related information area 302, a content server address information area 303 and a distribution reservation information area 304. The icon defining area 300 defines the basic information relating to the icon. In the example of FIG. 7, the identifier of this icon (ICON-ID) is icon-v101-349-v1, the owner (VENDOR) is FUJITSU, and the expiration date (EXPIRED) is Jan. 1, 2002. The icon appearance attribute area 301 defines an icon image displayed on the display unit. In the example of FIG. 7, the size of the image is defined as 200 in the lateral direction and 100 in the vertical direction and it is also set that the icon image URL is used as the image data. The product-related information area 302 defines the detailed information relating to the icon. In the example of FIG. 7, the icon is defined as a product icon. It is also defined that the product information (PRODUCT) and type of product (TYPE) is CD, price PRICE) is ¥3,000 and a singer (ARTIST) is Whitney Houston. When the relevant icon is displayed on the display unit, this information is displayed in an up-rush display manner when a cursor comes close to this icon or is displayed simultaneously with the icon at the area near such icon. The content server address information area 303 defines a server as the advertisement distributor of the relevant icon. In this embodiment, the server providing the virtual social space service is used in common as the server for advertisement distribution. Therefore, in the example of FIG. 7, the URL of the intermediate server 1 is defined. The distribution reservation information area 304 defines the information required for distribution reservation. In the example of FIG. 7, it is defined that both name (NAME) and e-mail address (EMAIL) are required as the profile information of the user when the reservation is distributed.

The distribution reservation requesting unit 25 recognizes the necessity of the name and e-mail address of the user to realize distribution reservation based on the icon data content of the distribution reservation information area 304 and acquires the name and e-mail address of the relevant user based on the member information DB 18 to generate the distribution reservation data in operation O202 of FIG. 3. An example of generated distribution reservation data is illustrated in FIG. 8 .

In the REQUEST-TYPE item, it is set that this data corresponds to distribution reservation. In the ICON-ID item, the icon ID icon-v101-349-v1 is acquired from the icon data of the icon manipulated by the user and this icon ID is then set. In the items of NAME and EMAIL, the name of user TARO FUJITSU and e-mail address taro01@xxx.xxx.jp are acquired by referring to the member information DB 18 using the user ID as the key and these data are then set. The generated distribution reservation data is transmitted to the intermediate server 1 in operation O203 of FIG. 3.

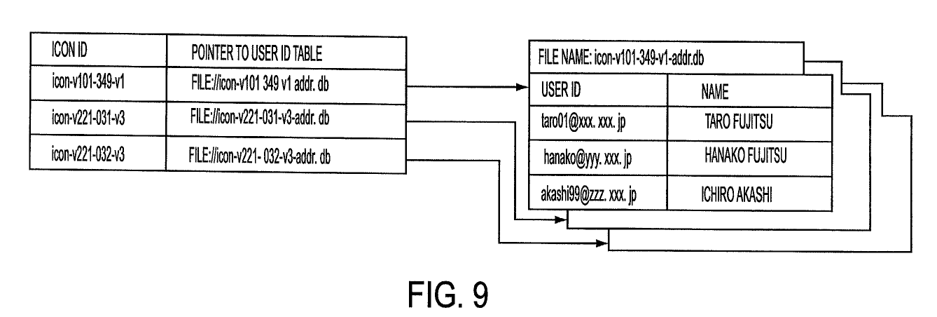

The distribution reservation management unit 13 of the intermediate server 1 updates, upon receiving the distribution reservation data in operation O301 of FIG. 3, the content of the distribution reservation management DB 12 based on the content of distribution reservation data. An example of the content of distribution reservation management DB 12 is illustrated in FIG. 9.

In this embodiment, the e-mail address taro01@xxx.xxx.jp and user name Taro Fujitsu as the advertisement distribution destination are registered to the icon ID icon-v101-349-v1.

Thereby, the user is capable of reserving the advertisement distribution to the advertisement distributor corresponding to relevant icon by moving the icon displayed on the display image to the predetermined domain.

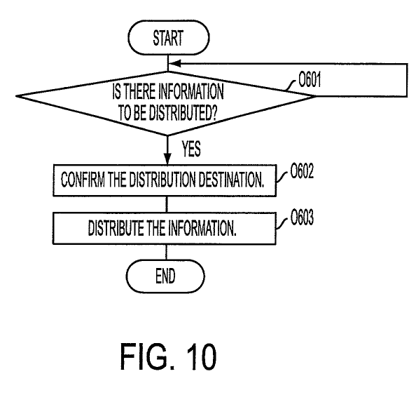

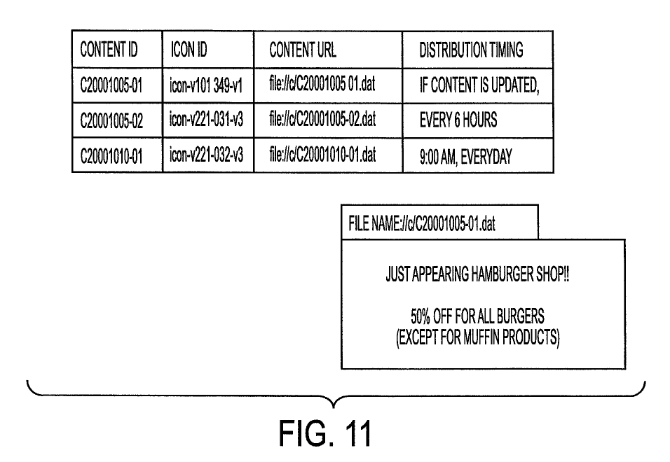

Next, the advertisement distribution process will be explained in conjunction with FIG. 10. The information distributing unit 14 of the intermediate server 1 refers to the content DB 11 to confirm that there is information to be distributed in operation O601 of FIG. 10. An example of the content of content DB 11 is illustrated in FIG. 11. The content DB 11 is composed of content ID, icon ID, content URL and distribution timing. The content ID is an identification code for identifying unique information. The icon ID is an identification number for identifying the icon. The content URL is an address (URL) storing the content of the advertisement to be distributed. The distribution timing defines the timing for transmitting the relevant content to the user. The content ID C20001005-01 defines distribution when it is detected that the information stored in the content URL is updated, while the content ID C20001005-02 defines distribution of information every six hours. Here, it is assumed that the content ID C20001005-01 is detected as the information to be distributed, YES in operation O601 of FIG. 10. The distribution reservation management DB 12 is searched using the icon ID icon-v101-349-v1 corresponding to the relevant content as the key in order to confirm the distribution destination in operation O602 of FIG. 10. Based on the distribution reservation management DB 12 illustrated in FIG. 9, three persons are registered in the icon ID icon-v101-349-v1 and following addresses taro01@xxx.xxx.jp, hanako@yyy.xxx.jp, akashi99@zzz.xxx.jp can be acquired as the distribution destination e-mail addresses. The obtained distribution destination e-mail addresses and the data (c20001005-01.dat) to be distributed to the distribution data are transmitted after processing in operation O603 of FIG. 10.

When the content receiving unit 27 receives the distributed advertisement, the user terminal 2 transmits it to the display image information generating unit 21. The display image information generating unit 21 generates an image data to display the received advertisement to the domain near the relevant icon and displays such image data to the display unit via the output processing unit 32. As illustrated in FIG. 6, the advertisement data 104 is displayed at the domain near the icon 102.

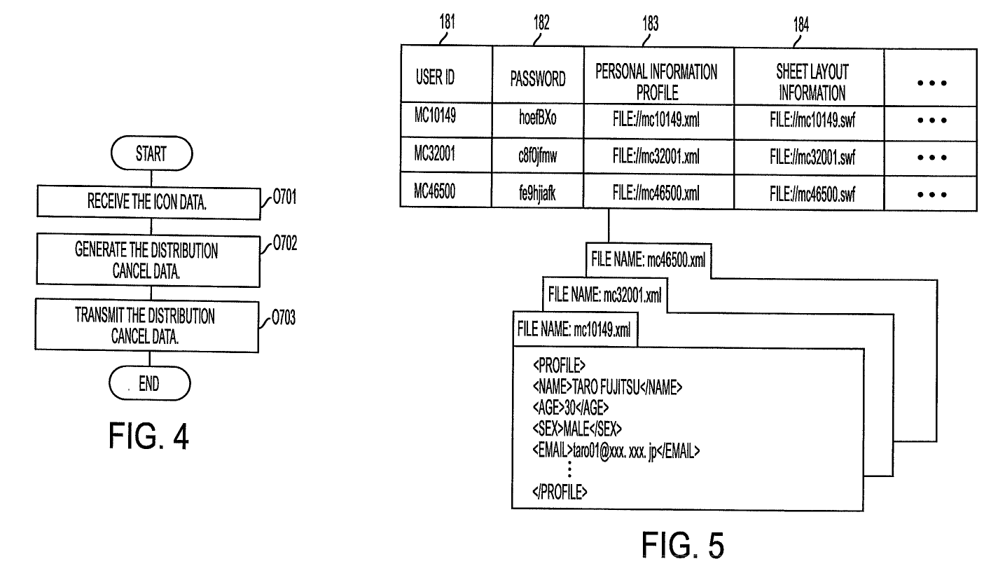

On the other hand, when the icon 105 registered to the advertisement requesting domain 200 is deleted in FIG. 6, the distribution reservation is cancelled. This cancel request process will be explained with reference to FIG. 4.

Here, it is assumed that the user deletes the icon 105 from the advertisement requesting domain 200. The icon position detecting unit 23 is notified by the request analyzing unit 22 when the icon is manipulated and detects that the relevant icon has been deleted from the advertisement requesting domain 200, namely from the predetermined domain, and thereafter transmits the relevant icon data to the cancel requesting unit 26. Upon reception of the icon data in operation O701 of FIG. 4, the cancel requesting unit 26 refers to the icon data distribution reservation registering information area 304 and confirms the items required for distribution reservation. Here, it is also assumed that the icon displayed in FIG. 7 is deleted. Upon confirming that the name and e-mail address of the user are necessary as the distribution reservation information, the cancel requesting unit 26 acquires this data from the member information DB 18. Based on the information acquired and icon ID, the distribution cancel data is generated in operation O702 of FIG. 4. The distribution cancel data is formed of the items indicated in FIG. 8. In the case of a distribution cancel, the distribution cancel is set in the REQUEST-TYPE item. In regard to the other items, the same content as the distribution reservation is set. The generated distribution cancel data is transmitted to the intermediate server 1 in operation O703 of FIG. 4. When the distribution cancel data is received, the distribution reservation management unit 13 searches the distribution reservation management DB 12 using the icon ID and distribution reservation information such as name and e-mail address as the key to delete the relevant distribution reservation.

Thereby, the user is capable of suspending the advertisement distribution only by deleting or moving the icon from the predetermined domain.

Next, adjustment of advertisement distribution depending on the rank of user's interest will be explained.

The flow of the process that the user terminal 2 detects manipulation for the icon and transmits the distribution reservation request to the intermediate server 1 is identical to that explained above. However, the icon coordinates position information is added, as illustrated in FIG. 8, as the content of the distribution reservation data to be transmitted. In this embodiment, the coordinates correspond to coordinates in the virtual social space 100 displayed as the display image of FIG. 6. In the POSITION item, two kinds of coordinates are set. In the AFTER item, the coordinates after completion of manipulation for the icon are set. In the BEFORE item, the coordinates immediately before manipulation for the icon are set.

Here, it is assumed that the icon 102, located in the virtual social space 100, is dragged and dropped to the advertisement requesting domain 200. In this case, in the AFTER item, the coordinates of icon 106 located in the advertisement requesting domain 200 are set and in the BEFORE item, the coordinates of icon 102 located in the virtual social space 100 are set.

Herein used is an effect that the icon located in the near point of the virtual social space 100 indicates a higher rank of user interest, while the icon located in the further point indicates a lower rank of user interest. When the virtual social space 100 does not provide different environments to respective users and provides a common environment to users, it is possible to use the coordinates of the icon in the advertisement requesting domain 200. Moreover, the coordinate position information is only the information to determine the rank of user interest and the expression format thereof is not always limited to the coordinates. For example, it can be thought that the correlation of a plurality of icons moved to the advertisement requesting domain 200 is calculated with a predetermined function and the result of this calculation is used and the user's manipulation records are stored and the result of analysis of its tendency is used.

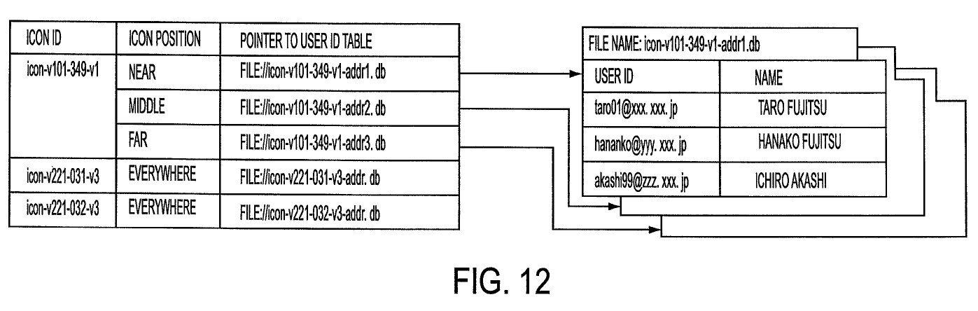

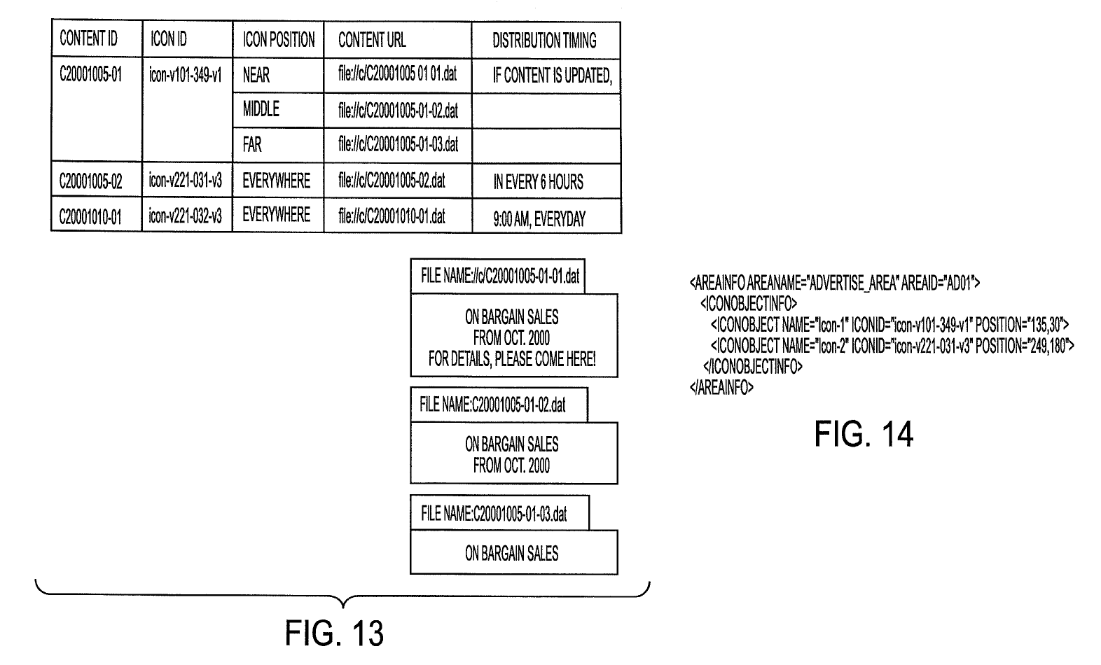

The distribution reservation management unit 13 determines, upon reception of the distribution reservation data in operation O401 of FIG. 3C, the positional division of icons from the coordinate position information of the distribution reservation data in operation O402 of FIG. 3. Namely, the rank of user interest is determined. In this embodiment, positional division of the icon is determined to three divisions of NEAR, MIDDLE, FAR as illustrated in FIG. 13. In the case of NEAR, the relevant icon is located in the forward domain in the virtual social space 100 to determine that the user interest level is very high. In the case of MIDDLE, the relevant icon located in the intermediate domain in the virtual social space 100 to determined that the user interest level is ordinary. In the case of FAR, the relevant icon is allocated in the further domain in the virtual social space 100 to determine that the user interest level is low. Together with the information about the user's interest rank, the icon position information is also registered to the distribution reservation management DB 12. An example of content of the distribution reservation management DB 12 in this case will be illustrated in FIG. 12. In addition to the items of FIG. 9, the icon item position is added. Based on the distribution reservation request illustrated in FIG. 8, the user ID, taro01@xxx.xxx.jp and name Taro Fujitsu are registered to the icon position NEAR of the icon ID icon-v101-349-v1.

Therefore, content of the content DB 11 is also structured as illustrated in FIG. 13. The icon position item is added to the items of the content DB illustrated in FIG. 11. Thereby, it is set so that advertisement content to be distributed is different depending on the icon position even when the icon is identical. When the icon position is NEAR in the icon ID icon-v101-349-v1, since the rank of user's interest level is high, the advertisement data having the most affluent content such as the event which is now opened, the opening period and the link information for referring to detailed information is distributed. When the icon position is MIDDLE, since the rank of user's interest level is intermediate, only the event which is now opened and the opening period thereof are distributed. Moreover, when the icon position is FAR, since the rank of user's interest level is low, only the event which is now opened is distributed. The information distributing unit 14 groups, on the occasion of confirming the information distributing destination in operation O601 of FIG. 10, the distributing destinations with the icon ID and icon position based on the content of the distribution reservation management DB 12 in the information distribution adjusting unit 15 and generates the distribution data to respectively distribute the content to the advertisement content corresponding to the icon ID and icon position in the content DB 11.

Thereby, distribution of advertisements can be realized depending on the rank of user's interest level.

Moreover, in the case where a plurality of icons are located within the predetermined domain on the occasion of sending the distribution reservation request by moving the icon to the predetermined domain, it is also possible for such icons to send additional data as illustrated in FIG. 14 together with the distribution reservation data. In FIG. 14, two icons already exist in the advertisement requesting domain 200 and the icon IDs icon-1 and icon-2 of such icons and the coordinate positions of respective icons are set. Moreover, when the advertisement requesting domain 200 is the interface of which domain is divided respectively for the rank of user's interest level, field of rank and each sorting of products, the domain where such icon group exists is previously set to the AREAINF0 item. Thereby, a tendency of user's interest or the like can be analyzed and, therefore, it is also possible to change the advertisement content depending on the results of such an analysis.

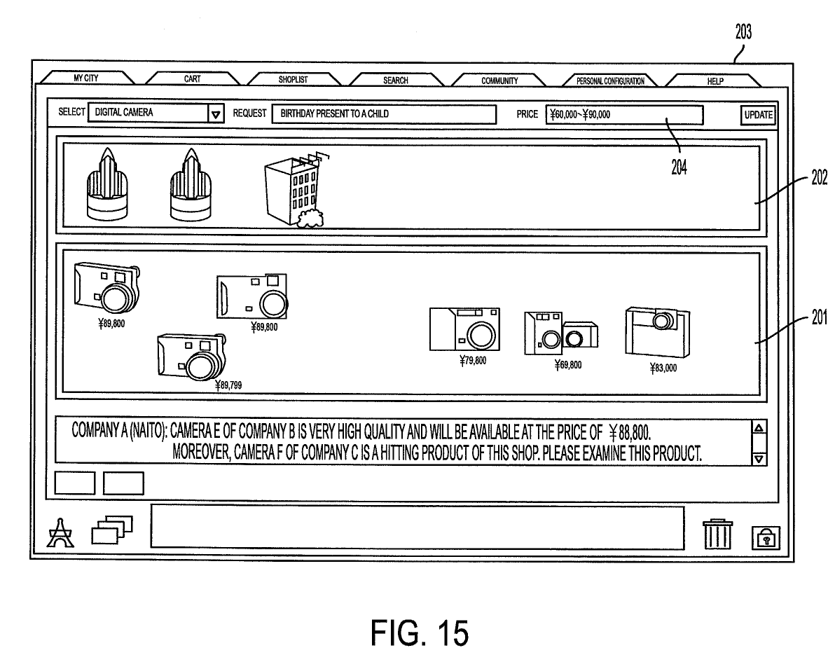

For example, this is particularly effective in a shopping cart system as illustrated in FIG. 15. In the shopping cart system, the user temporarily stores products which are now under consideration to be purchased within the candidate product domain 201 of the shopping cart. In an example of FIG. 15, the user registers six cameras under consideration to buy when purchasing a camera. Here, it is assumed that the user has additionally registered another camera to the candidate product domain 201. When only the information about the added camera is notified to the server, a member of the camera shop cannot recognize whether the user is only interested in such a camera or whether the user is comparing this camera with another camera. In this case, it is possible, at the time of sending the distribution reservation, the advertisement distributor can detect the user's interest level and demand by transmitting, together the information about not only the icon of the manipulation object but also the icons existing in the periphery of such object icon, and thereby can distribute the advertisement including the content for emphasizing the advantages to purchasing the advertisement distributing source's camera in place of the cameras of the other makers.

Moreover, in this case, it is also possible that the distribution reservation requesting unit 25 not only sends the distribution reservation regarding the icon as the moving manipulation object but also transmits the distribution reservation with an attachment including information regarding the icons existing in the periphery of the object icon for the icons existing in the periphery transmitted as the additional data. Thereby, sellers of the products which are the objects of the purchase investigation can take part in a fair selling competition. Moreover, the user is now capable of receiving, from the seller of each product, the advertisement emphasizing the advantages of the relevant product over the other candidate products and thereby is also capable of making the decision depending on the user's needs by receiving, as required, the determination factors to select the product which is finally purchased.

Moreover, the application field not only of the other products registered to the candidate product domain 201 but also of shops registered to the purchase planning shop domain 202 and products being set in comment column 203 and the estimated cost being set in amount column 204 can be thought as the object of the peripheral information. Thereby, a shop can recognize the other shops placed in a competitive relationship and can distribute an advertisement taking into consideration the rival shops. Moreover, a shop is capable of distributing advertisement content just matched with the customer's application and presenting price reduction amount depending on the estimated amount by detecting the budget of customer and product application and thereby a shop can provide more delicate services considering the needs of the customers.

The advertisement allowing domain 200 may be displayed in the same manner as the virtual social space 100. In this case, the icon position in the advertisement allowing domain 200 is linked with the user's interest level just as in the case that the icon position in the virtual social space 100 is linked with the user's interest level. Moreover, the icon display profile may be changed depending on the icon position. For example, the icon placed in the forward position is displayed in a larger size to more clearly indicate the higher rank of user's interest, while, on the contrary, the icon placed in the backward position is displayed in a smaller size to clearly indicate the lower rank of user's interest. In addition, various display profiles may be introduced so long as the difference may be easily discriminated, for example, by employing different concentrations of color or brightness.

As the domain of the virtual social space 100, it is possible to display the homepage (web page) allowing ordinary access in place of the display image connected to the particular services explained above. It is sufficient when the icons displayed on this homepage have the function of the present invention and the icon display profile is not specified in this embodiment. When the icon displayed on the homepage is moved to the advertisement requesting domain 200, the information requesting process of the present invention is executed. In this case, when the advertisement requesting domain 200 links the icon position and user's interest level rank, it is now possible to send the information request depending on the user's interest level.

Moreover, in the case of receiving the distributed information which depends on the information request and displaying this information to the user terminals, such information is displayed as an example to the domain near the relevant icon but when such information is received as an e-mail, it may be displayed using the mail software or such received information may be displayed by providing an exclusive display domain.

Next, an example of the information to be distributed including the icon having the functions of the present invention will be explained.

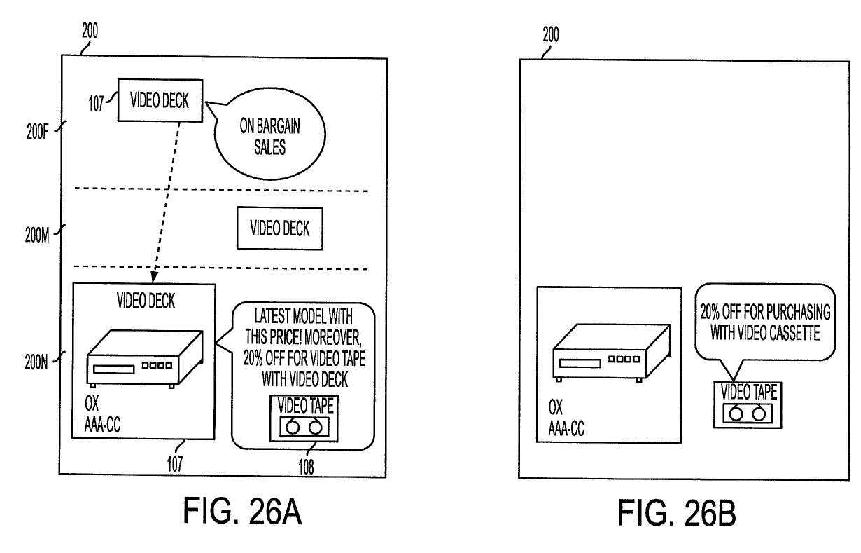

FIG. 26(a) and FIG. 26(b) illustrate only the advertisement allowing domain 200. The icon position in this advertisement allowing domain 200 is related to the user's interest level rank. When the icon is placed to the lower stage 200N of the advertisement allowing domain 200 located at the forward domain viewed from the user, it suggests that the interest corresponding to the icon of user is high, and when the icon is placed to the intermediate stage 200M and upper stage 200F of the advertisement allowing domain 200, it suggests that the interest corresponding to the icon of user is lowered.

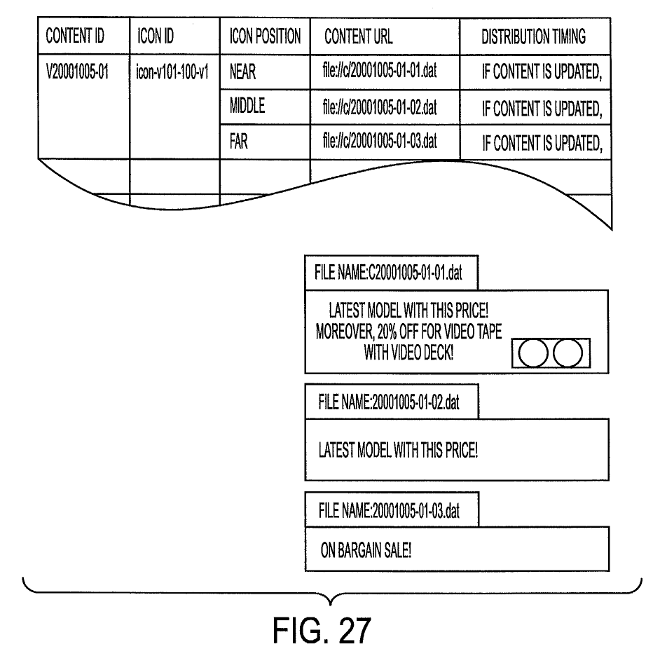

Moreover, an example of content of the content DB 11 is illustrated in FIG. 27. In FIG. 27, three kinds of information pieces are registered depending on the position of icon 107 (icon ID: icon-vd01-100-v1) of the video deck A. Particularly, the icon 108 of accessory is defined together with the advertisement information of accessory as the content of the content file: //c/V20001005-01-01.dat corresponding to the icon position NEAR indicating that the user is very much interested in the relevant icon. In FIG. 27, an icon image is described directly as to the detail of content in order to make clear the image, but in actuality, the description is made to conform to the regulations for describing the details of content, for example, by describing the keyword for referring to the icon and the icon ID of the destination for reference.

In the example of FIG. 26(a), the user initially registers the icon 107 of the video-deck A to the upper stage 200F of the advertisement allowing domain 200. When the icon is placed at the upper stage 200F of the advertisement allowing domain 200, it is detected, like the process explained above, that the relevant icon is moved to the advertisement allowing domain 200, the information distribution reservation for the relevant icon including the position information of the icon in the advertisement allowing domain 200 is executed and the advertisement depending on the icon position is extracted from the content DB 11 (FIG. 27) based on the distribution reservation information registered, this advertisement is then distributed to the user terminal and thereby the advertisement for the relevant icon can be displayed. In FIG. 26(a), since the icon exists in the upper stage 200F of the advertisement allowing domain, it suggests the rank of interest to this icon of the user is low and only the advertisement content corresponding to this interest level “On Discount sale!!!” is displayed. Thereafter, when the user moves the icon 107 of the video-deck A to the lower stage 200N of the advertisement allowing domain 200, it is detected that the icon has been moved as in the case of the process explained above, it is then notified to the distribution reservation management unit 13 that the relevant icon position has changed and the advertisement content depending on the icon position after the movement is distributed. When the icon is moved to the lower stage 200N indicating that the interest level of user is high, the advertisement content is changed to content for further urging a purchase such as “You can get the latest model with this fantastically lower price!!!” corresponding to such interest level. Moreover, as explained previously, since the advertisement content regarding the video-tape “Moreover, 20% off! for the paired video-tape” and the icon 108 of the related product (video-tape in this case) are further registered as related product information to the content DB, such information pieces are also displayed.

In regard to the icon 108 displayed with the advertisement, the information may be provided depending on the user's interest level as illustrated in FIG. 26(b) by moving the icon 108, as explained above, to the advertisement allowing domain 200 with the manipulations such as drag and drop or the like. Since the icon of the related product is also displayed together with the advertisement information, the user can easily acquire the information of the related product and can easily register the related product to the advertisement allowing domain 200.

In the content DB 11 illustrated in FIG. 27, the icon 108 of the related product and the icon information are described in the contents stored corresponding to each icon, but the other profile may also be introduced.

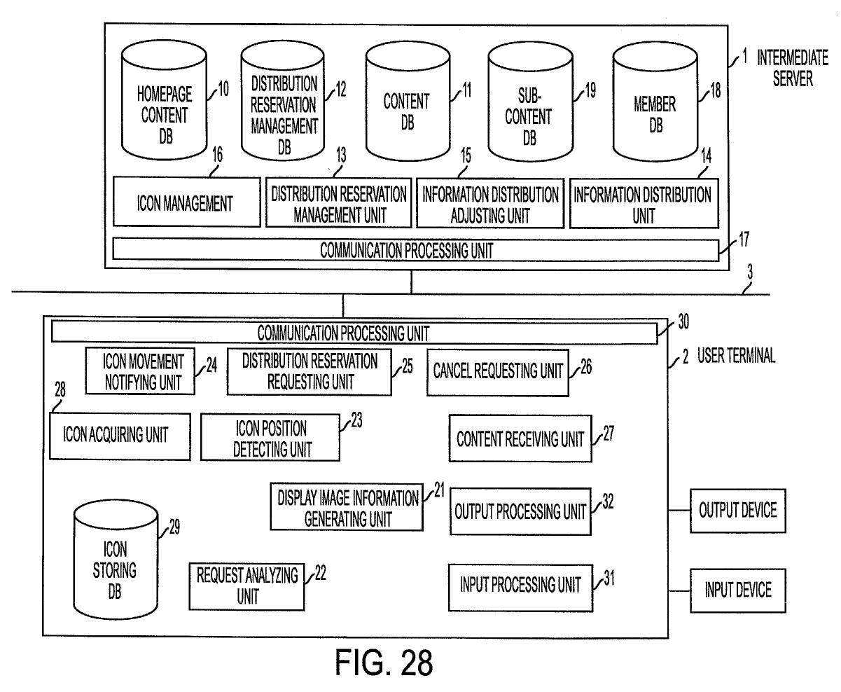

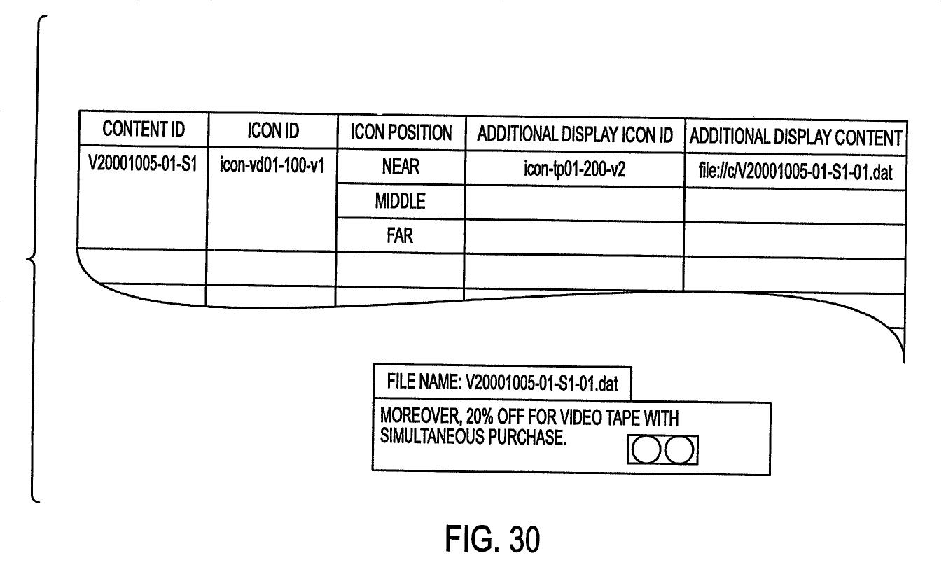

For example, as illustrated in FIG. 28, the sub-content DB 19 is also provided. The sub-content DB 19 stores the corresponding icons (for example, related products and accessories or the like) in relation to the icons (for example, products). FIG. 30 illustrates an example of the sub-content DB 19. The sub-content DB 19 is composed of content ID, icon ID, icon position, additional display icon ID and additional display content or the like. In the column of content ID, the identification information for identifying the content is stored. In the column of the icon ID, the identification information for identifying the icon as the additional display object is stored. In the column of the additional display icon ID, the identification information of the icon which is additionally displayed corresponding to the icon ID is stored. In the column of the additional display content, the address storing the information to be additionally displayed corresponding to the icon ID is stored. Here, the additional display icon ID and additional display content are not always required to be stored individually and in the case where the identification information of the additional display icon ID is described to the content of the additional display content, it is possible that the column of the additional display icon ID is not provided and it is included in the additional display content.

In this case, the content DB 11 stores only the information about the icons as is illustrated in FIG. 11 and FIG. 13.

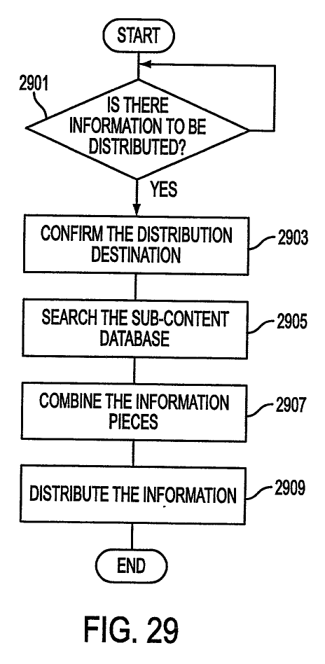

The flow of the process of the information distributing unit 14 wherein the sub-content DB 19 is used will be explained based on FIG. 29.

The information distributing unit 14 detects that the icon has been manipulated within the advertisement allowing domain 200 or a defined event has been generated at the distribution timing of the content DB 11 in operation O291. In the example of FIG. 26, it is detected that the icon 107 of video-deck A (icon ID: icon-vd01-100-v1) is moved within the advertisement allowing domain 200.

The icon corresponding to the detected manipulation or event is identified, the content DB 11 is searched, the content to be distributed is identified and moreover the information distribution destination is extracted by referring to the distribution reservation management DB 12 in operation O2903.

The icon ID, additional display icon ID stored corresponding to the icon position and address of the additional display content are obtained in operation O2905 by searching the sub-content DB using, as the keys, the icon ID of the icon for distributing information and the icon position as required. In the example of FIG. 28, using the icon ID icon-vd01-100-v1 of the icon 107 of the video-deck A and the icon position NEAR after the moving manipulation as the keys, the sub-content DB is searched to obtain the additional display icon ID: icon-tp01-200-v2 and the additional display content address file://c/V20001005-01-S1-01.dat.

The distribution information is generated by combining the information stored corresponding to the icon, additional display icon and additional display content in operation O2907.

The combined information is transmitted to the distribution destination in operation O2909.

As illustrated in FIG. 28(a), the user terminal having received the distributed information displays the information including the additional display icon to the domain near the icon or to the predetermined column.

Moreover, it is also possible for the user that the icon 108 of the related product displayed as the advertisement information is moved to the advertisement allowing domain 200 only with an instruction to the icon 108 without manipulation of the icon 108 to the advertisement allowing domain 200. In this case, when the manipulation for the icon is detected and it is detected that the movement to the predetermined domain is not conducted in operation O104 of FIG. 2, a NO in operation O105, the operation to determine whether the manipulation is conducted to the icon in the advertisement is further added. When it is determined that the icon is included in the advertisement information, the icon position of the product as the display source of the relevant advertisement information is obtained as the display position of the icon included in the advertisement information and it is then transmitted, together with the icon ID of the related product, to the distribution reservation requesting unit 25 and display image information generating unit 21. The distribution reservation requesting unit 25 generates the distribution reservation data based on the notified icon ID and icon position and then transmits this data to the distribution reservation management unit 13. The distribution reservation management unit 13 registers the related product to the distribution reservation management DB 12 based on the notified distribution reservation data.

Thereby, when an icon is a symbolic image representing a product, it is now possible to display the icon of the product related to the relevant product including advertisement information relating to the relevant product. In the case where the icon of the product sold in the shop and the icon of the product related to the relevant product are stored correspondingly in the Internet shops in which a plurality of shops are taking part, when the user has moved a certain shop's product to the advertisement allowing domain 200, the icon of the related product sold by the same shop being stored corresponding to such a product can be displayed as the advertisement information and moreover the user can easily transmit the purchase or purchase investigation of the related product to the advertisement distributor by manipulating the icon of the related product being displayed. Moreover, it is also possible to urge a customer to purchase the related product in the same shop and thereby sales of that same shop can be increased through the strategic registration to the sub-content DB.

Next, an example of linkage between the schedule management system and the present invention will be described.

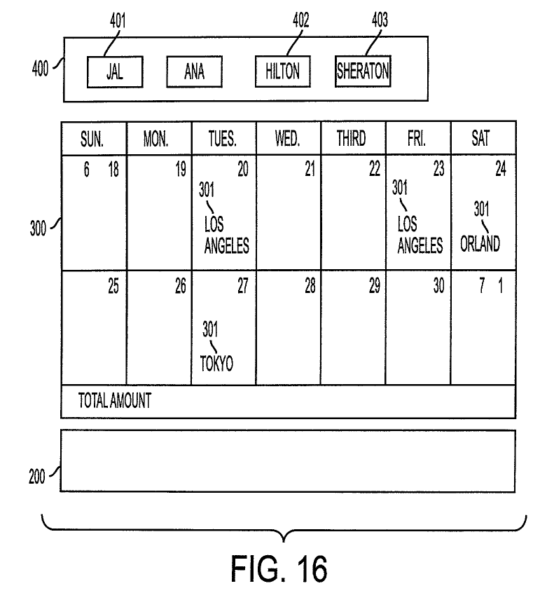

Such linkage will be explained on the basis of the display image examples shown in FIG. 16 to FIG. 21.

In the display image of the user terminal 2, the schedule table 300 and information requesting domain 200 are displayed.

The user inputs the user's own schedule 301 to the schedule table 300. In an example of FIG. 16, it is inputted that the user will stay in Los Angeles from June 20th to 23rd, in Orland on June 24, and in Tokyo on June 27. According to this schedule, since nothing is registered to the information requesting domain 200, only the update of schedule database is executed.

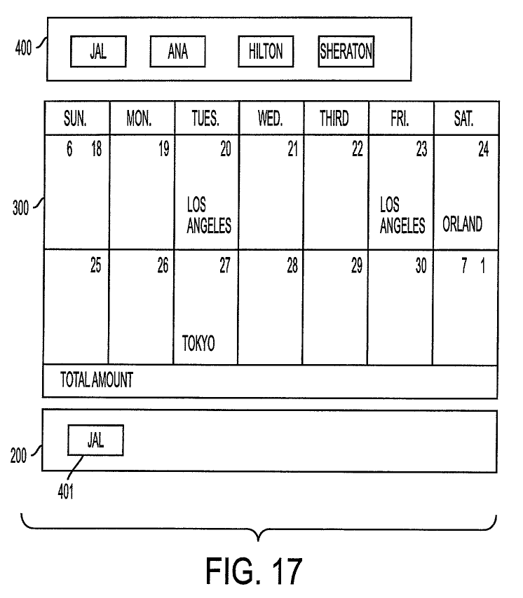

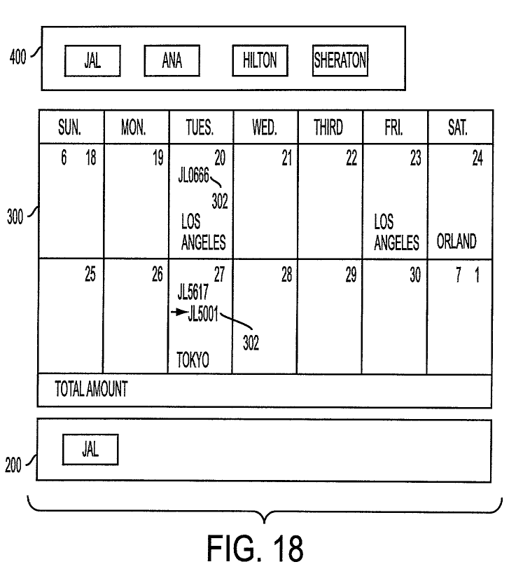

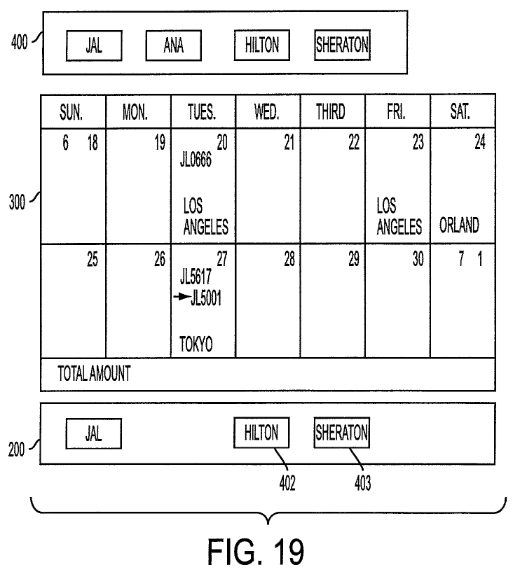

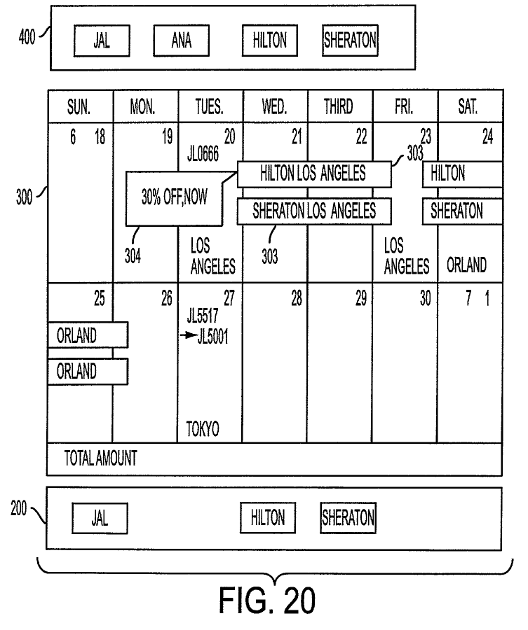

Next, it is assumed that the icon 401 of an airline is registered to the information requesting domain 200 (FIG. 17). Since the icon 401 is registered to the information requesting domain 200, the server is requested to set the distribution reservation as explained previously. In this case, not only the icon information but also the content of the schedule table 300 are transmitted as additional information. Thereby, the user schedule is transmitted to the reservation management system of the selected airline. The reservation system of the airline transmits the flight schedule depending on the user's schedule to the user based on the schedule data of user. The user terminal 2 receives the flight schedule and displays it to the relevant column 302 in the schedule table (FIG. 18). Here, it is assumed that the icons 402, 403 of the lodgings or the like are registered (FIG. 19). The user registers two candidate hotels. The content of the schedule table and the other candidate hotels are notified to each candidate hotel. Each hotel notifies the campaign information together with an allowable duration of stay to the user. Here, since it is also notified to respective hotels that the other hotels are also listed as candidates, it is possible for the campaign information to change the fixed content to a content for lowering the price lower than the other hotels or for providing different services and to add the content explained above to the fixed content. The user terminal 2 displays the allowable duration of stay 303 and the campaign information 304 (FIG. 20).

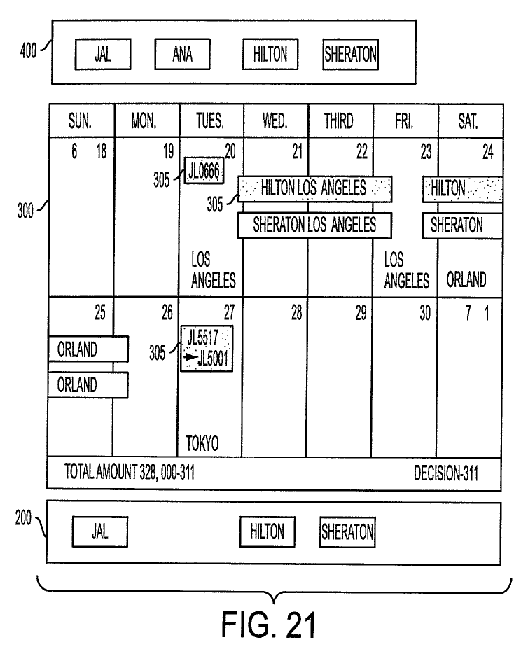

Moreover, when the user selects the available flight 305 and the allowable duration of stay 303, it is detected that a change is generated in the related information and the selected flight is notified to the relevant airline, while the selected allowable duration of stay is transmitted to the relevant hotel. The airline and hotel having received the selected information respectively transmit the application charges. The user terminal displays, upon receiving the application charges, the total application charge 310 (FIG. 21). A decision button 311 displayed in the right side of the total column is depressed, the reservation application information of the relevant flight and hotel is generated and is then transmitted to the server. The server updates the reservation application management DB and also transmits a reservation number or the like to the user terminal. The user terminal displays the notified reservation information.

As explained above, the user can confirm the diagram information, flight information and vacancy conditions of hotels considering the user's own schedule only by inputting the user's own schedule and then moving or copying the icons of the available transportation facilities and lodging facilities to the predetermined domains. Moreover, when the system is incorporated into the reservation management system, the user can send the reservation application with a similar manipulation.

The user is now capable of obtaining the information and applying for services with only a simple manipulation such as moving the icons.

Next, an example of cooperation with information services provided by a talent company will be explained. The user terminal displays a catalog domain 600 in which the icons of talents of which information can be obtained, the domain of schedule table 500 for user schedule management and displaying the talent information obtained and an information requesting domain 200 for setting the talent of which information is requested. The domain of the schedule table 500 is structured to receive, by clicking a tab, various services such as reading an electronic magazine (magazine tab), reference and applying for ticket information (ticket tab), purchase of various products (online shopping tab), video recording of television programs (TV reservation tab), accompanying performance with musical instruments (jukebox tab) and mail services (user mail tab).

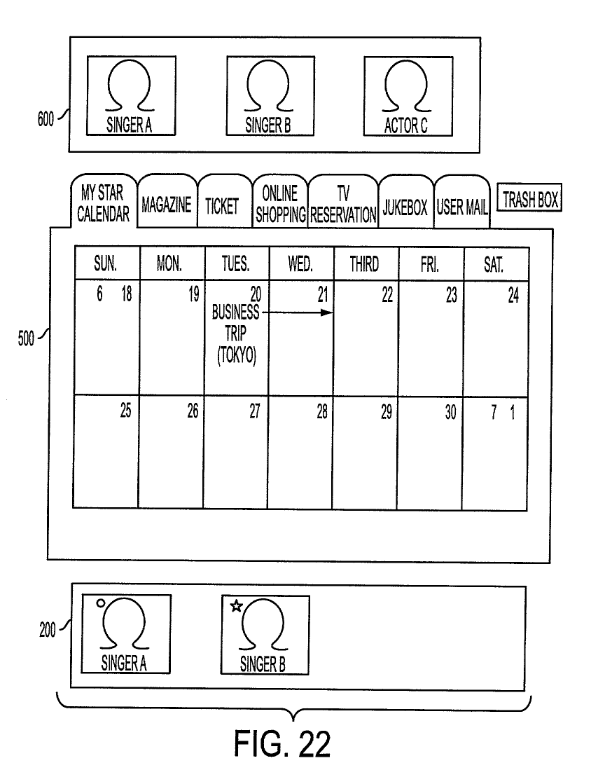

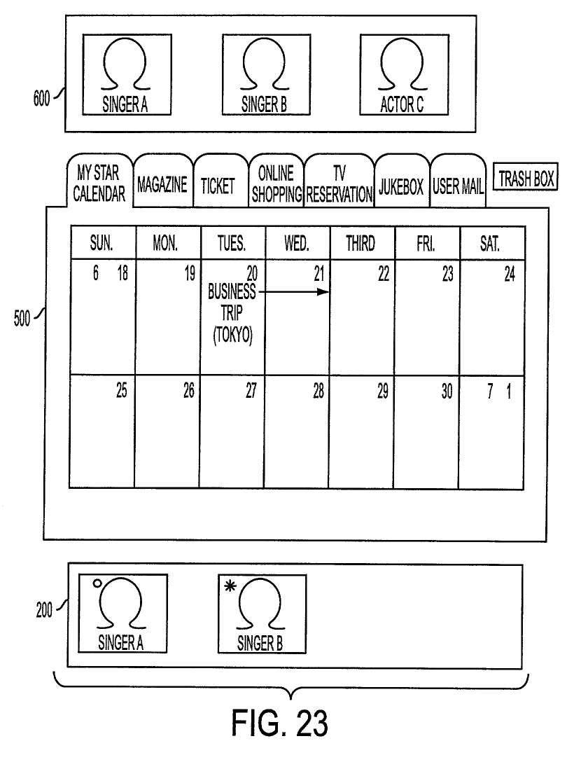

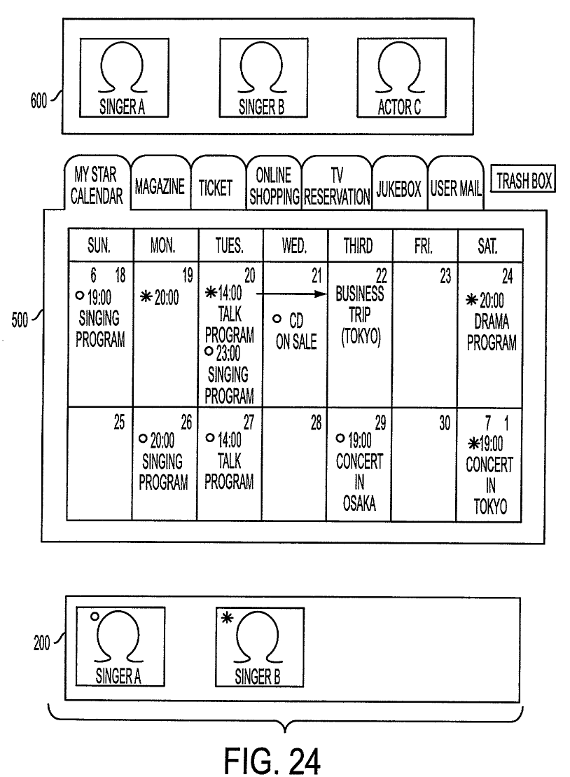

FIG. 22 illustrates a display image after the user is connected to the relevant service. In FIG. 22, the schedule table in which the schedule of the user to stay in Tokyo from June 20 to June 21 is registered and is displayed. Here, it is assumed that the user has copied the icons of the singers A and B to the information requesting domain 200 from the catalog domain 600 (FIG. 23). When it is detected that the icons are copied to the information requesting domain 200, the information acquiring request for the singers A and B is transmitted to the server. Upon reception of the information acquisition request, the server collects the information pieces of singers A and B such as concert schedule and schedule for appearing on TV and then transmits such information to the user terminal. Upon receiving the information from the server, it is then displayed on the domain of schedule table 500 (FIG. 24). The date information is displayed in the columns of the corresponding dates of the schedule table 4500. Moreover, the icon of the information requesting domain 200 is given each mark respectively. Moreover, the singer A is given the mark °, while the singer B is given the mark *. The information displayed in the schedule table 500 is displayed with the mark to clearly discriminate the singers. In the example of FIG. 24, a singing program at 7:00 on June 18 is information which relates to singer A and is given the mark °. Moreover, the singing program at 20:00 on June 19 is information which relates singer B and is given the mark *.

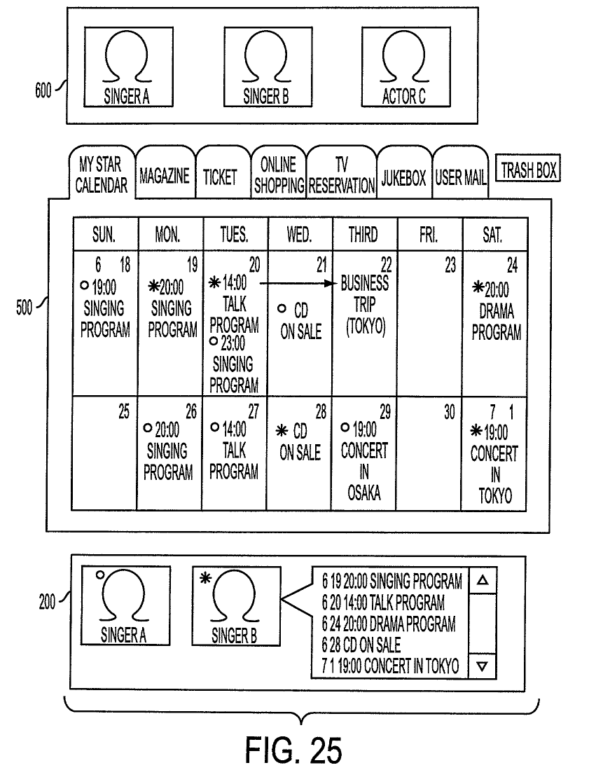

Thereby, the user is now capable of confirming the schedule information of the relevant talent in the calendar format only by manipulating the icon of the favorite talent. Moreover, when this calendar format is incorporated into the schedule table of the user, the user is capable of simultaneously displaying his own schedule and the schedule of his favorite talent. On the other hand, it is also possible that when it is requested to know only the concentrated information of such talent, only the information of such talent can be displayed with the up-rush display method as illustrated in FIG. 25 by placing a mouse cursor on the icon of the talent in the information requesting domain 200. FIG. 25 illustrates an example where the mouse cursor is placed on the icon of the singer B. Moreover, in addition to the concentrated display on the other domain, it is also possible to realize the emphasized display for discrimination, for example, the information of the singer B displayed in the column of the schedule table 500 is then displayed in different colors or displayed inversely. Moreover, it is possible for display to combine such display manners.

Moreover, it is also possible that when the user selects one of the schedule information pieces of the talent displayed in the schedule table 500 and drags and drops such information to the “magazine” and “ticket” tabs, the service corresponding to each tab can be received. For example, it is scheduled that a CD of the singer A will be on sale on June 21. It is also provided that when this information is dragged and dropped to the “Online Shopping” tab, the CD purchasing procedures are requested from the server. Moreover, two programs of the favorite singers are scheduled during the period from June 20 to June 21, while the user must go on a business trip. When the information of this program is dropped to the TV reservation tab, the video reservation may be transmitted to the server, or recording to the disc drive in the user terminal may be set or the reservation information may be transmitted to the connected video apparatus, as required.

The system structure of FIG. 1 illustrates an example where the server of the service provision apparatus, information distribution and advertisement distributor is used in common as the various service provision servers of the virtual social space service, shopping cart service and reservation system operated in cooperation, but it is also possible that each service is operated respectively with different servers and or operated in cooperation among various servers.

According to above explanation, the user is capable of sending a request for application of desired services and information only by executing simplified manipulation such as movement of the symbolic images such as icon and object or the like to the desired domain.

Moreover, the user is now capable of promoting sales activities of the products particularly at a shopping store which is virtually set on the network by providing the information including the other symbolic images in relation to the symbolic image moved to the predetermined domain.

What is claimed is:

1. A method for requesting information provided over a network, comprising:
displaying at least one symbolic image representing at least one respective information provider on a user terminal;
displaying a predetermined domain for declaring an information request;
detecting that a user has selected at least one symbolic image and moved the selected symbolic image to the predetermined domain; and
requesting the information from the information provider corresponding to the selected symbolic image.

2. A method for requesting information as claimed in claim 1, wherein the predetermined domain is divided into divisions having respective different locations on a display of the user terminal display, such divisions corresponding to an interest level for the requested information, wherein information distribution is requested based on the level corresponding to the moved position of the selected symbolic image.

3. A method for requesting information as claimed in claim 1, wherein when it is detected that a symbolic image has been moved to the predetermined domain, it is detected whether other symbolic images exist in the predetermined domain and, when it is detected that other symbolic images exist, the information is requested, including information relating to the other symbolic images, from information distributors corresponding to the other symbolic images.

4. A method for requesting services from a service provider, comprising:
displaying a symbolic image representing a service provider on a user terminal,
displaying a predetermined domain for declaring use of service; and
detecting that a user has selected the symbolic image corresponding to the service provider and moved the symbolic image to the predetermined domain.

5. A service application apparatus comprising:
a service provider display displaying, on a user terminal, a symbolic image corresponding to a service provider for providing services via a network;
a service request domain display displaying, on the user terminal, a service request domain for requesting services;
a detector detecting that a user has moved the symbolic image displayed on the user terminal to the service request domain;
a service requesting unit identifying the symbolic image detected with the detector, generating service requesting data and transmitting the service requesting data to the service provider corresponding to the symbolic image; and
a service providing unit providing, on the user terminal, the services provided from the service provider.

6. A service application apparatus as claimed in claim 5, wherein said service provider display further comprises:
a changing unit for changing a display position of the symbolic image depending on a user manipulation, and
a management unit managing the display position of the symbolic image for each user, wherein
said service requesting unit transmits symbolic image display position information as an object of selection to the service provider in addition to the service requesting data and
said service providing unit executes a service adjusted depending on the display position of the symbolic image from the service provider.

7. A service application apparatus as claimed in claim 5, wherein
said detector detects a position of the symbolic image on the service request domain and notifies this position to the service requesting unit,
said service requesting unit transmits the position of the symbolic image on the service request domain to the service provider together with the service requesting data and
said service providing unit provides services, adjusted depending on the position of the symbolic image on the service request domain, from the service provider.

8. A service application apparatus as claimed in claim 5, wherein
said service requesting unit detects whether other symbolic images already exist in the service request domain and also transmits such symbolic images together with the information about the other symbolic images to the service provider when the other symbolic images are detected.

9. An information providing system for periodically transmitting desired information in response to an application from a user transmitted via a network, comprising:
an information provider display displaying a symbolic image representing an information provider on a user terminal;
an information requesting domain display displaying, on the user terminal, an information request domain to accept an information request;
a detector detecting that a user has selected one or a plurality of symbolic images corresponding to the information provider to detect that the selected symbolic image is moved to the information requesting domain;
an information requesting unit identifying the symbolic image detected with the detector and transmitting generated data for requesting information from the information provider corresponding to the selected symbolic image; and
an information display displaying the information distributed from the information requesting unit.

10. An information providing system as claimed in claim 9, wherein
said information provider display includes a position changing unit changing a display position of a symbolic image in response to a user manipulation and a management unit managing the display of the symbolic image for each user,
said information requesting unit transmits the information requesting data to the information provider including a display position of the symbolic image as a selection object and
said information display receives the information adjusted in accordance with the display position of the symbolic image from the information provider and displays the information.

11. An information providing system as claimed in claim 9, wherein
said detector detects a position of the symbolic image on the information requesting domain and then transmits the position data to the information requesting unit,
said information requesting unit transmits the information requesting data to the information provider, including the position of the symbolic image on the information requesting domain, and
said information display displays the information adjusted depending on the position of symbolic image on the relevant information requesting domain from the information provider.

12. An information providing system as claimed in claim 9, wherein
said information requesting unit detects whether other symbolic images already exist in the information requesting domain and transmits, when the other symbolic images are detected, information relating to the other symbolic images to the information provider.

13. An advertisement distributing system for periodically distributing advertisement information from an advertisement distributor to users via a network, comprising:
an advertisement provider display displaying, to the users, a symbolic image corresponding to the advertisement distributor;
a display displaying, on the user terminals, an advertisement requesting domain for accepting an advertisement distribution reservation;
a detector for detecting that a user has selected one or a plurality of symbolic images corresponding to an information provider and has moved the symbolic image to the advertisement requesting domain;
an advertisement distribution reservation requesting unit identifying the symbolic image detected with the detector and generating and transmitting distribution reservation requesting data to the advertisement distributor corresponding to the relevant symbolic image; and
an information display displaying the advertisement information distributed from the advertisement distributor to the user terminal corresponding to the user.

14. An advertisement distributing system as claimed in claim 13, wherein
said advertisement provider display includes a position changing unit changing the display position of a symbolic image in response to a user manipulation and a management unit managing the display position of the relevant symbolic image for each user,
said advertisement distribution reservation requesting unit transmits the distribution reservation requesting data to the advertisement distributor, including the display position of the symbolic image as a selection object, and
said information display receives and displays the advertisement information adjusted depending on the display position of the relevant symbolic image transmitted from the advertisement distributor.

15. An advertisement distributing system as claimed in claim 13, wherein
said detector detects a position of symbolic image on the advertisement requesting domain and transmits the position data to the advertisement distribution reservation requesting unit,
said advertisement distribution reservation requesting unit transmits the distribution reservation requesting data to the advertisement distributor including the position of the symbolic image on the advertisement requesting domain and
said information display displays the advertisement information adjusted depending on the position of symbolic image on the relevant advertisement requesting domain from the information distributor.

16. An advertisement providing system as claimed in claim 13, wherein
said advertisement distribution reservation requesting unit detects whether other symbolic images already exist in the advertisement requesting domain and also transmits, when the other symbolic images are detected, information relating to the other symbolic images to the advertisement distributor.

17. An advertisement distributing system as claimed in claim 13, wherein
said information displaying means receives the advertisement information including other symbolic images relating to the relevant symbolic image from the advertisement distributor and displays the advertisement information on a user terminal together with the other symbolic images.

18. An advertisement distributing system as claimed in claim 13, wherein
said detector further includes a determining unit determining whether an icon in which a manipulation is performed corresponds to the symbolic image included in the advertisement information and acquires, when the symbolic image is included in the advertisement information, the positional information relating to the symbolic image as the object of the relevant advertisement information existing in the relevant advertisement requesting domain and also transmits the symbolic image included in the advertisement information and the obtained positional information to the advertisement distribution reservation requesting unit and
said advertisement distribution reservation requesting means also includes a generating unit generating the distribution reservation requesting data based on the symbolic image included in the advertisement information transmitted with the detector and the obtained positional information.

19. A terminal apparatus for an information providing system for accepting an information distribution request from a user via a network and distributing the desired information to the user, comprising:
an information provider display for obtaining a symbolic image representing an information distributor via the network and displaying the symbolic image on a user terminal;
an information requesting domain display displaying an independent predetermined domain;
a detecting unit detecting that a user has selected one or a plurality of symbolic images displayed and has moved the selected symbolic image to the predetermined domain;
an information requesting unit generating an information request for the information distributor corresponding to the selected symbolic image and transmitting this request to the user terminal; and
an information display displaying the information transmitted from the information source on the user terminal.

20. A terminal apparatus for information an providing system as claimed in claim 19, wherein
said information provider display includes a position changing unit changing a display position of a symbolic image depending on user manipulation and a management unit managing the display position of the relevant symbolic image for each user,
said information requesting unit transmits the information requesting data to the information provider including the display position of the symbolic image as the selection object and
said information display receives the information adjusted in accordance with the display position of the symbolic image from the information provider and displays the information.

21. A terminal apparatus for an information providing system as claimed in claim 19, wherein
said detector detects a position of the symbolic image on the information requesting domain and transmits the position data to the information requesting unit,
said information requesting unit transmits the information requesting data to the information distributor, including the position of the symbolic image on the information requesting domain and
said information display displays the information adjusted in accordance with the position of the symbolic image on the information requesting domain from the information distributor.

22. A terminal apparatus for an information providing system as claimed in claim 19, wherein
said information requesting unit detects whether other symbolic images already exist in the information requesting domain and transmits, when the other symbolic images are detected, information relating to the other symbolic images to the information provider.

23. A server used in an information distributing system for accepting an information request from a user via a network and distributing the requested information to the user, comprising:
a transmitter transmitting symbolic images previously stored which correspond to respective information distributors to a user terminal via the network;
a distribution reservation management unit updating a database for managing distribution destinations for each relevant symbolic image based on the transmitted information distribution request, the information distribution request corresponding to a selected symbolic image; and
an information provider distributing the requested information based on content of the database provided for managing the information distribution destinations.

24. A server used in the information providing system as claimed in claim 23, wherein
said distribution reservation management unit includes a rank determining unit obtaining a display position of the symbolic image transmitted to the user terminal, determining an interest level rank depending on the display position and storing the display position information together with the rank information in the database and
said information provider includes a distribution information adjusting unit adjusting an amount of information distributed to a user based on the rank information stored in the database.

25. A terminal apparatus used in an advertisement distributing system for accepting a distribution reservation request from a user via a network and distributing the requested advertisement information to the user, comprising:
an advertisement distributor display obtaining and displaying a symbolic image representing an advertisement distributor via the network;
an advertisement requesting domain display displaying an independent predetermined domain;
a detector detecting that a user has selected one or a plurality of symbolic images and has moved the selected image to the predetermined domain;
a distribution reservation requesting unit generating distribution reservation requesting data for the advertisement distributor corresponding to the detected symbolic image and then transmitting the distribution reservation requesting data to the user; and
an information display displaying advertisement information transmitted from the advertisement distributor to the user terminal.

26. A terminal apparatus used in advertisement distributing system as claimed in claim 25, wherein
said advertisement distributor display further includes a position changing unit changing a display position of a symbolic image in response to a user manipulation and a management unit managing the display position of the symbolic image,
said distribution reservation requesting unit transmits the distribution reservation requesting data to the advertisement distributor together with the display position of the symbolic image as a selection object, and
said information display receives the advertisement information adjusted in accordance with the display position of the symbolic image from the advertisement distributor and displays the advertisement information.

27. A terminal apparatus for advertisement distribution service as claimed in claim 25, wherein
said detector detects a position of symbolic image on the advertisement requesting domain and transmits the position data to the distribution reservation requesting unit,
said distribution reservation requesting unit transmits the distribution reservation requesting data to the advertisement distributor, together with the position of the symbolic image on the advertisement requesting domain; and
said information display displays the advertisement information adjusted depending on the position of the symbolic image on the relevant advertisement requesting domain from the information distributor.

28. A terminal apparatus for advertisement providing system as claimed in claim 25, wherein
said distribution reservation requesting unit detects whether other symbolic images already exist in the advertisement requesting domain and transmits, when the other symbolic images are detected, information relating to the other symbolic images to the advertisement distributor.

29. A server apparatus used in advertisement distributing system for accepting a distribution reservation request from a user via a network and distributing the requested advertisement information to the user, comprising:
a transmitter transmitting symbolic images previously stored which correspond to respective advertisement distributors to a user terminal via the network;
a distribution reservation management unit updating a database for managing advertisement distribution destinations of each relevant symbolic image based on the transmitted distribution reservation request corresponding to a selected symbolic image at the user terminal; and
an information provider distributing the requested advertisement information based on content of the database for managing the advertisement distribution destinations.

30. A server apparatus used in the advertisement distributing system as claimed in claim 29, wherein
said distribution reservation management unit includes a rank determining unit obtaining a display position of the symbolic image transmitted to the user terminal, determining an interest level rank depending on the display position and storing the display position information together with the interest level rank in the database, and
said information distributor includes an advertisement information adjusting unit adjusting the advertisement information to be distributed to the user based on the rank information stored in the database.

31. A memory medium used in a terminal apparatus for the an information providing system among those for accepting an information distribution request from a user via a network to store a program for a user terminal used in the information providing system for the requested information to the user, comprising:
displaying a symbolic image representing an information distributor obtained via the network on the user terminal;
displaying a domain used for a predetermined object;
detecting that at least one symbolic image is allocated to the domain,
transmitting the information distribution request to the information distributor, which is corresponds to a detected symbolic image; and
displaying information transmitted from the information provider to the user terminal.
